(19) United States
(12) Patent Application Publication
(10) Pub. No.: US 2007/0240249 A1
(43) Pub. Date: Oct. 18, 2007

(54) Individual Protection Equipment with Lamellar Structure

(76) Inventors: Jean Marc Poirier, Chantilly (FR); Patricia Phalip, Montargis (FR); Alain Guinault, Cregy Les Meaux (FR)

Correspondence Address: MORGAN LEWIS & BOCKIUS LLP, 1111 PENNSYLVANIA AVENUE NW, WASHINGTON, DC, 20004, US

(21) Appl. No.: 10/586,147

(22) PCT Filed: Jan. 17, 2005
(86) PCT No.: PCT/FR05/00099

§ 371 Date: Jun. 15, 2007

(30) Foreign Application Priority Data
Jan. 16, 2004 (FR) 0400401

(51) Int. Cl. A41D 19/00; B29C 49/00

(52) U.S. Cl. 2/457; 264/515

(57) ABSTRACT

The invention concerns individual protection articles whereof the walls are made of a continuous phase of polyolefin matrix wherein is dispersed a material forming barrier against chemicals and a compatibility agent. The invention also concerns a method for preparing such a material comprising mixing the constituents, extruding it the form of a film and drawing it to the desired thickness.

The invention relates to an article consisting of a film made of a thin contiguous lamellar material impermeable to chemicals and able to be converted in three dimensions. It also relates to novel personal protective articles intended for protection against chemicals and to a process for manufacturing them.

To protect users handling hazardous chemicals, it is customary practice to use multilayer materials that include at least one layer of a material impermeable to said chemicals, that is to say a barrier material. The effectiveness of the barrier effect of a material is determined by its permeation resistance, which is a measure of the time for a given chemical to pass through the material. The materials used to manufacture personal protective articles must also have a sufficient strength and sufficient puncture resistance for a standard use, for example in a laboratory or a workshop.

In particular, it has been proposed to use, in coextruded films, an ethylene/vinyl alcohol copolymer (EVOH), polyvinyl acetate or polyvinyl alcohol as materials impermeable to chemicals. The reader may for example refer to the following documents: U.S. Pat. No. 5,491,022; U.S. Pat. No. 5,059,477; U.S. Pat. No. 4,855,178; and U.S. Pat. No. 5,162,148. To be able to be used as a barrier layer in protective garments or gloves, these materials, of high melting points, are covered on both their faces with polyolefin films (such as polyethylene or polypropylene film). This is because polyolefins can be easily heat-welded and therefore allow several parts of the polyolefin/barrier material/polyolefin multilayer to be assembled in a sealed manner. Furthermore, although polyolefins are generally not very resistant to permeation, the presence of polyolefin films makes it possible to protect the barrier material from any degradation due to the external environment, whether this be of mechanical origin (contact with abrasive or rough materials) or chemical origin (degradation due to aggressive chemicals). The polyolefin films provide good protection against water in all its forms.

However, the chemically-resistant protective multilayer materials described above have the drawback of being able to be manufactured only in two-dimensional form. This is because such multilayer materials cannot be easily thermoformed, that is to say deformed and curved under the action of heat, since such a treatment would result in the formation, in the regions of the multilayer that have been deformed, of regions where the multilayer material exhibiting a barrier effect no longer forms a continuous network and therefore loses its permeation resistance properties in those regions.

Having chemically-resistant materials presented in two-dimensional form is particularly disadvantageous, in particular in the case of gloves—the flat shape of said materials make them ergonomically deficient and unable to match the natural shape of the wearer's hands. Their ergonomic deficiency makes these gloves particularly uncomfortable to wear and the wearer loses dexterity in his movements. This is because such two-dimensional gloves resist the movements of the hand and give rise to tensilely stressed areas at the folds for the fingers, so that the user is unable to perform meticulous movements and precise handling operations.

Moreover, articles having a contiguous lamellar structure are known, in the packaging field, which consist of a heterogeneous blend of a polyolefin and a polymer incompatible with this polyolefin, which is dispersed in the polyolefin by means of a compatibilizing material. The barrier properties result from this particular structural arrangement of the blend of the two polymers and the essential criterion lies in the contiguity of the lamellae, this being an essential criterion for obtaining good barrier properties, comparable or even better than those of conventional multilayers. The polymer dispersed in the polyolefin may be a chemical barrier material such as an ethylene/vinyl alcohol copolymer (EVOH). The reader may refer to the following documents which describe such articles: U.S. Pat. No. 4,410,482; U.S. Pat. No. 4,971,864 and J. B. Faisant et al. (Polymer, 1998, 39(3), 533-545).

The articles manufactured hitherto from such heterogeneous materials were rigid or semirigid articles—sheets prepared by stretching the material—or packaging articles, bottles and containers.

In the case of the articles obtained in U.S. Pat. No. 4,410,482, the three-dimensional articles with a contiguous lamellar structure are prepared by extrusion blow molding, but their minimum thickness is then much too great for the desired application. In the case of the films obtained in U.S. Pat. No. 4,410,482, pressing the extruded films does not allow a contiguous lamellar structure to be obtained.

In the case of the articles described by J. B. Faisant et al. (Polymer, 1998, 39(3), 533-545), these are manufactured from a dispersion of EVOH in polypropylene. Although the author describes sheets with a thickness possibly down to 200 μm, the material employed does not give said sheets sufficient flexibility to allow them to be used in personal protective articles.

Patent U.S. Pat. No. 4,971,864 and the SELAR®RB brochure from DuPont describe articles manufactured from a dispersion of EVOH in a polyolefin, which may be polyethylene. These articles may be sheets prepared by stretching the heterogeneous material or the articles in three dimensions obtained by extrusion blow molding. However, the articles described in the above documents still have a thickness greater than 500 μm, which is much too great for a personal protective article such as for example a glove.

A person skilled in the art who applies a conventional forming process for a sheet of an EVOH/polyolefin dispersion, as described in U.S. Pat. No. 4,971,864, in order to obtain a three-dimensionally thermoformable article with a thickness of less than 200 μm would see the chemical barrier properties, and in particular the solvent barrier properties, of this sheet deteriorate, making it unsuitable for use as a personal protective article. This is because, since the contiguous lamellar structure is a thermodynamically unstable structure, heating it results in an irreversible modification of the contiguous lamellar structure to a noncontiguous lamellar structure, or even to a nodular structure.

Document EP-0 189 270 describes articles made of a blend consisting of a continuous polyolefin phase and a discontinuous phase chosen so as to provide the material with the desired properties, such as vapor barrier properties.

A compatibilizer may be employed. The discontinuous phase may be made of a polyamide or copolyamide, a polyester, polycarbonate, polystyrene, polyacrylonitrile, or ethylene/polyvinyl alcohol copolymer.

The process consists in passing the blend through a rotating tubular extruder so as to improve the distribution of the discontinuous phase in the continuous phase. The material obtained has a contiguous lamellar structure. The extrusion may be followed by blowing, by applying gas pressure inside the extruded tube. The extruded film tube may also be blow molded in a mold so as to give it the desired shape.

However, blow molding an extruded film in a mold cannot be used to obtain thin articles, for fear of the film cracking and/or losing the contiguity of the lamellar structure. The process described in that document therefore does not make it possible to obtain articles with a three-dimensional structure having the property of being a solvent barrier.

Document U.S. Pat. No. 5,338,502 describes articles obtained by molding EVOH into which a polyolefin and possibly a compatibilizer are incorporated.

The two raw materials are melt blended. The blend is molded to the desired shape, for example so as to form a film, by extrusion. These articles are impermeable to gases and can then be converted by thermoforming. The articles described in that document do not have a lamellar structure and are rigid, while their solvent impermeability is insufficient.

A person skilled in the art would have been unable to predict, on reading this prior art, that it was possible to manufacture films with a contiguous lamellar structure, impermeable to chemicals, especially to solvents, fine and able to be converted three-dimensionally so as to produce articles with a contiguous lamellar structure of sufficient flexibility and sufficient ergonomic design, but nevertheless having remarkable chemical barrier properties, allowing them to be used as personal protective articles.

Consequently, the object of the invention is a process for manufacturing a protective article with a contiguous lamellar structure from a heterogeneous material comprising:
(a) a polyolefin or a blend of polyolefins;
(b) at least one material forming a barrier to chemicals, this material having a melting point at least 5° C. above the melting point of the polyolefin (a); and
(c) at least one compatibilizer for allowing the barrier material (b) to be dispersed in the polyolefin (a),
   said process comprising the following steps:
(i) blending of constituents (a), (b) and (c);
(ii) extrusion of the blend obtained at (i) so as to form a film tube;
(iii) stretching of the film tube obtained at (ii) advantageously by stretch blow molding; and
(v) thermoforming of the film obtained at (iii) at a suitable temperature,
   steps (iii) and (v) being controlled so that the thickness of the article at all points is between 60 and 190 μm, preferably between 80 and 160 μm and even more preferably 100 to 140 μm.

According to the invention, in step (i), the blending of components (a), (b) and (c) takes place without these three components being melt preblended.

Component (a) may be polyethylene, polypropylene, polybutylene or a copolymer thereof.

Preferably, according to the invention, component (a) is polyethylene. It may be high-density, medium-density or low-density polyethylene. Advantageously, a low-density polyethylene is chosen.

Component (b) may be chosen from: polyamides; polyesters, such as polyethylene terephthalate and polybutylene terephthalate; polycarbonates; ethylene/vinyl alcohol copolymers; polyvinyl acetate and polyvinyl alcohol.

Advantageously, according to the invention component (b) is an ethylene/vinyl alcohol copolymer. Preferably, this copolymer contains 20 to 60% by weight of ethylene units relative to the total weight of the copolymer (b). According to the invention, the copolymer (b) has a melting point at least 5° C. above that of the polyolefin (a), and even more preferably 10° C. above that of the polyolefin (a).

Preferably, according to the invention the compatibilizer (c) is a polyolefin onto which carboxylic units, that is to say groups chosen from carboxylic acids, esters, anhydrides and carboxylic acid salts, have been grafted.

Advantageously, according to the invention the compatibilizer (c) is a polymer comprising polyolefin units onto which cyclic anhydride fragments are grafted, said polyolefin unit being compatible with the polyolefin (a), the cyclic anhydride fragments being in an amount such that the percentage by weight of carbonyl functional groups relative to the total weight of the compatibilizer (c) is between 0.1 and 4%.

Preferably, in the blend of constituents (a), (b) and (c) these are introduced in amounts such that: the polyolefin (a) represents from 60 to 95%, preferably 70 to 90%, by weight of the weight of the blend; component (b) represents from 2 to 40%, preferably 3 to 20% and even more preferably 4 to 12%, by weight of the total weight of the blend; and component (c) is introduced in an amount such that the weight of the carbonyl functional groups of compound (c) represents 0.14 to 0.6% of the weight of component (b).

As regards the materials (a), (b) and (c) the reader may refer to documents U.S. Pat. No. 4,971,864 and U.S. Pat. No. 4,410,482, which describe them in detail.

The films obtained by the process according to the invention have a polyolefin continuous phase in which fine lamellae of barrier material (b) are dispersed, these lamellae being substantially parallel to and overlapping one another.

The process according to the invention includes the following steps:
(i) the blending of constituents (a), (b) and (c) by any means known to those skilled in the art so that any two specimens taken from the blend always have substantially the same proportions of components (a), (b) and (c). Advantageously, components (a), (b) and (c) are blended in the form of solid particles, which are conveyed to an extrusion screw. Preferably, a blend of solid particles with a size ranging from 0.5 to 10 mm, preferably 1 to 7 mm and even more preferably 2 to 4 mm is used. The compatibilizer (c) may be incorporated in the form of a powder so as to make it easier to disperse it;
(ii) after a homogeneous blend of the three components has been prepared, said blend is conveyed to an extruder in which it is heated to a temperature above the melting point of component (b).

Advantageously, an extruder that minimizes the blending of the components is used.

If the material (b) is EVOH, the extrusion temperature of the blend is advantageously chosen to be between 195 and 240° C.

The blend is then extruded through a die, which preferably is of the radial-channel helical type or of the flat type.

The temperature at the die is preferably adjusted to be a few degrees above the melting point of component (b).

The rotation speed of the extrusion screw may be between 40 and 100 rpm, preferably between 60 and 100 rpm.

What is obtained from the die is a film with a thickness ranging from 0.5 mm to 3 mm, preferably 0.5 mm to 2 mm.

On leaving the extruder, the film is blown and stretched by stretch blow molding.

The blowing is carried out on the film tube in the melt. A blow ratio ranging from 1 to 5, preferably 1.5 to 3, and a stretch ratio ranging from 1 to 5, preferably 2 to 4, are applied.

The film constituting the tube is cooled by exposing it to air or water, or by using a roll, preferably in air. This cooling is carried out in a controlled manner so as to prevent the film from losing its barrier properties by a rupture in the structure of the film. The cooling conditions are tailored according to components (a), (b) and (c), to their proportions in the blend and to the thickness of the film.

A person skilled in the art will adjust the cooling rate by carrying out trials as described in the examples: for a given blend and a given film thickness, he would prepare several films with variable cooling rates and then measure the solvent permeability of the cooled films so as to optimally adjust this parameter to the nature of the film. What is then obtained is a film tube.

The film obtained by this process is both thin and chemically resistant, and is also able to be converted three-dimensionally. Such a film may be used as such, as protective material, in the form of a protective garment or cover for example.

After the film has undergone this stretching step, it may be thermoformed.

According to the invention, the stretching and thermoforming of the film are carried out under suitable conditions for obtaining an article having walls with a thickness between 60 and 190 μm, advantageously 80 to 160 μm and even more advantageously 100 to 146 μm.

A person skilled in the art knows how to modify, by simple trials, the known means for stretching the film so as to adjust the thickness of the final article. These modifications consist of the die gap thickness, the blow ratio and the stretch ratio.

The thermoforming, also known as forming, consists in creating regions making a relief relative to the plane initial structure of the film. For example, the thermoforming may be used to create comfort areas in a personal protective article, such as a glove, so as to make it of more ergonomic design and to make finger mobility and gripping movements easier.

The forming is carried out by using a mold of suitable shape, according to the article that it is desired to manufacture. This mold is heated to a sufficient temperature to allow the forming of the film to take place, but not too high in order to prevent the contiguous lamellar structure deteriorating.

The thermoforming is a combination of preheating the film to a certain temperature and forming the preheated film in a mold.

The preheating must be carried out at a temperature between the glass transition temperature of the barrier phase and the melting point of the matrix, in order to avoid any diminution in the barrier properties of the film, which is observed if the preheating is performed outside this temperature range.

For example, in the case of an EVOH polymer dispersed in low-density polyethylene, the preheating temperature is chosen to be between 80 and 120° C., more advantageously between 90 and 110° C., and advantageously a mold heated to a temperature between 50 and 80° C. is used.

Surprisingly, if the preheating temperature is above the glass transition temperature of the barrier layer and also above the melting point of the polyolefin, then the constituent lamellae of the barrier phase contract spontaneously, and self-destruction of the contiguous lamella structure is then observed, with the subsequent loss of its impermeability properties. It is therefore necessary to preheat the film between these two critical temperatures (the glass transition temperature of the dispersed phase and the melting point of the polyolefin) and preferably a temperature 5 to 15° C. below the melting point of the polyolefin in the case of an EVOH/low-density polyethylene blend.

According to another variant of the invention, the process further includes, between steps (iii) and (v), a complexing step (iv). This consists in adding a nonwoven based on a polymer compatible with polymer (a) to one face of the film. If (a) is a low-density polyethylene, a polyethylene-based nonwoven is preferably chosen.

The nonwoven is advantageously chosen in such a way that it has a melting point close to the melting point of the polyolefin and slightly above the melting point of the polyolefin so as to form a complex between the film with a contiguous lamellar structure and a nonwoven by thermal bonding without degrading the structure of the nonwoven. It is also possible to use an adhesive having a melting point slightly below that of the polyolefin.

For example, in the case of complexing with a film of PE/EVOH lamellar structure, it is preferred to use a nonwoven based on high-density PE and a Surlyn-type polyolefin adhesive having a melting point of 97° C.

The complexing may be carried out after step (iii).

Finally, for the manufacture of personal protective articles, the process of the invention may furthermore include a welding step (vi), in which two films of lamellar material, possibly complexed with a nonwoven, are welded together in a known manner by thermal-pulse or laser welding.

The welding and/or forming steps make it possible, starting from a film, to obtain flexible and ergonomic products of three-dimensional structure. Furthermore, these products have barrier properties with respect to chemicals in general and to solvents in particular.

Another subject of the invention consists of a personal protective article, the walls of which are made of a material consisting of:
(a) a continuous polyolefin phase in which is dispersed;
(b) at least one material forming a barrier to chemicals, this material having a melting point at least 5° C. higher than the melting point of the polyolefin (a); and
(c) at least one compatibilizer allowing the barrier material (b) to be dispersed in the polyolefin (a), at least one portion of this article being thermoformed, this material having a thickness ranging from 60 μm to 190 μm, preferably between 80 and 160 μm and more preferably 100 to 140 μm.

The articles according to the invention may be of various shapes and formats—they may for example be gloves, overshoes, overalls, hoods, shrouds or covers.

The contiguous lamellar character of the material of the invention may be observed by microscopy. It may also be evaluated by measuring helium permeability.

To display the lamellar structure of the films and 3D products having high barrier properties is a difficult and lengthy process. A novel measurement of the helium permeability of the films has been developed and a good correlation observed between the measured values and the structure of the films tested. Helium is a gas characterized by a high rate of dissolution in polymers compared with that of liquids, solvents, acids and bases. This technique makes it possible to rapidly differentiate between a contiguous lamellar structure, a non-contiguous simple lamellar structure and a nodular structure.

According to the evaluation method employed in the invention, the helium permeability of the material prepared by the process of the invention and of a film of the same thickness consisting of polyolefin (a) is measured. The ratio of the permeability of the material of the invention to the permeability of polyolefin (a) is called the “helium barrier enhancement factor”.

It is found that, according to the process of the invention, materials having an enhancement factor of at least 3, preferably at least 4 and even more preferably at least 5 are obtained.

This helium permeability test is used to predict with very high reliability the solvent barrier quality of the material of the invention.

The invention will be better understood from the following examples, which are intended to illustrate it.

### EXAMPLES

The chemical permeation resistance tests were carried out according to the NF EN 374-3 standard.

### Example 1

### Manufacture of a Personal Protective Glove

I. Production of the Film

1) Contiguous and Continuous Lamellar Structure

The films were produced from a defined polymer blend and under the conditions specified below, which made it possible to obtain a structure referred to as a contiguous and continuous “lamellar” structure. This continuity or contiguity is essential for obtaining the desired barrier properties. The lamellar structure is a structure consisting of a PE matrix in which the EVOH is present in the form of a multitude of approximately parallel thin layers overlapping one another.

2) Blend and Constituent Polymers

The blend was based on:
low-density PE, with the reference 1008 FE 24 sold by Atofina;
EVOH, with the reference L101, sold by Mitsui; and
compatibilizer, with the reference SELAR® A100 sold by DuPont de Nemours.

These polymers were chosen according to the following criteria:
the PE as polyolefin for its good chemical resistance and its impermeability to water vapor, and more particularly radical low-density PE for the comfort that it provides compared with high-density PE and more rigid polypropylene;
the EVOH L101 (a grade having a maximum vinyl alcohol content) for its high barrier properties; and
SELAR® A100 as compatibilizer for obtaining thick hollow bodies with a lamellar structure of EVOH in a polyolefin.

The proportions used in this blend were the following (by weight relative to the total weight of the blend):
88% PE 1008 FE 24;
6% EVOH L101; and
6% SELAR® A100.

3) Drying and Preparation of the Blend

The blend of the 3 components was initially prepared by the “drum” method after the drying of the EVOH alone or of the EVOH/SELAR blend at 80° C. for 4 hours in a ventilated oven.

4) Process for Producing the Films

The films were produced by the extrusion process with a tube blowing tool. Extrusion is a process which, by adapting the conversion conditions and the tools (cf. section 5), makes it possible to obtain a continuous lamellar structure upon leaving the die.

To produce the films, the extrusion blow molding process was preferably used, allowing the continuity of the contiguous lamellar structure to be maintained thanks to:
sufficiently rapid cooling so as to avoid “relaxation of the continuous lamellar structure” to a noncontiguous lamellar structure or even, in the case of longer cooling times, to a fibrillar structure and then to a nodular structure; and
biaxial stretching, which seemed preferable to uniaxial stretching for maintaining said structure. Uniaxial stretching by itself results in longitudinal stretch ratios that are too high for obtaining the desired thickness, whereas the combination of lateral stretching (inflation) combined with longitudinal stretching made it possible to reduce the latter and thus retain the continuity of the lamellar structure.

5) Equipment Conditions

Extruder:

The extruder used was an extruder of the MAPRE brand characterized by a diameter D of 30 millimeters and a length of 33D, the cylinder head of the barrel being grooved.

The extrusion screw had to have a gentle profile, in order to minimize the blending of the various polymers, and without additional mixing elements. It had to be of conventional form with three simple zones.

Die:

The die was preferably of the radial-channel helicoidal type so as to avoid the presence of weld lines prejudicial to the mechanical quality of the film (finned die) or the generation of very thin regions (side-fed die).

It consisted of a mandrel 50 millimeters in diameter with a gap thickness having a conventional value of 0.8 millimeters. The height of the homogenizing element was equal to that of the element comprising the helicoidal channels.

Temperatures, Screw Rotation Speed and Cooling:

The temperatures required in the die were between 190° C. and 215° C. and advantageously were 197° C. The screw rotation speed could be between 40 and 80 rpm, but it was ideally set at 60 rpm.

Cooling Conditions:

The cooling was carried out by means of a conventional cooling assembly comprising a blowing ring fed via six inlets with air generated by a blower. The flow rate of air output by the blower was adjustable using the damper of the blower and the position of the central iris allows the pressure of the blowing air to be adjusted. To produce the film according to the invention, the iris was placed in the low position so as to increase the pressure of the cooling air and the flow rate of the blower was at an intermediate setting. Under these conditions, the tube was blown immediately it left the die and a sufficient air flow rate then allowed the tube thus formed to be cooled as rapidly as possible, thus preventing any relaxation of its microstructure.

The adjustment of the parameters was evaluated by measuring the permeability of the film output by the machine (tetrahydrofuran/toluene permeation test) using the method described below.

Blowing and Stretching:

The blow ratio was ideally 1.9, which corresponded on the machine to the almost maximum blow ratio permissible for this type of blend with the die used.

The stretch was also an important parameter as it determines the thickness of the film. The stretch ratio used was 2.9 in order to obtain a film with a local minimum thickness of 120 microns and a mean thickness of 140 μm.

II. Complexing and Forming

The complexing and forming operations were the two phases of the manufacture of gloves that had to contribute to improving their comfort. The tests were carried out not on gloves but on small areas (23.7 cm² at most) allowing their barrier properties to be measured.

The complexing consisted in adding a nonwoven to the internal face of the glove. This nonwoven was based on polyethylene.

The nature of the nonwoven was selected according to the following criteria:
a melting point close to the melting point of the barrier film of 110° C. so as to allow bonding at a temperature relatively close to that of the barrier film for the purpose of preventing it from degrading;
however, a melting point slightly above that of the barrier film so as to allow complexing by thermal bonding at a temperature not resulting in the melting of the nonwoven.

The only nonwovens meeting these requirements were nonwovens made of high-density polyethylene having a melting point of 130° C.

The adhesion of the nonwoven to the barrier film was provided by a thin (about 10 to 20 microns thick) film of Surlyn 1652° (an ionomer resin sold by DuPont de Nemours), the advantage of which was the low melting point (97° C.), below that of the barrier film. This allowed sufficient adhesion of the nonwoven to the barrier film without the barrier properties of the film being modified and without the nonwoven forming a film.

The complexing process adopted was a thermal bonding process between heated platens at a temperature between 95° C. and 105° C., i.e. a temperature 5 to 15° C. below the melting point of the polyolefin.

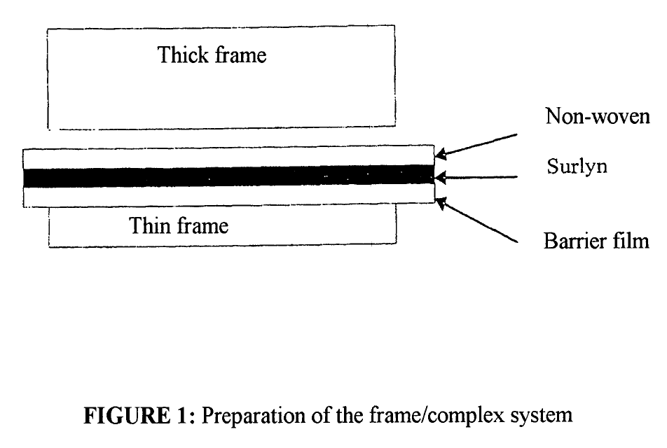

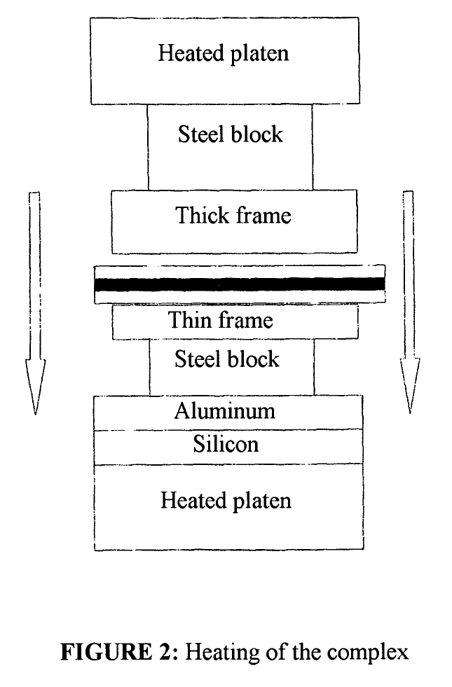

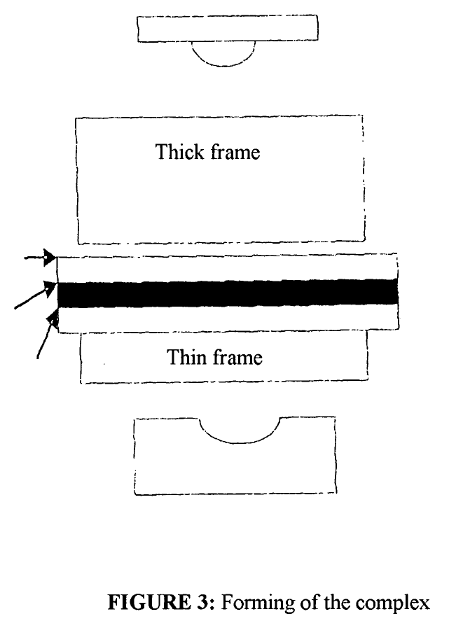

The forming operation was used to add “comfort bumps” on the back of the glove. The proposed process made it possible for the complexing and the forming operations to be carried out simultaneously. Diagrams showing the principle of the complexing/forming process are given in FIGS. 1 to 3:
the complex was placed between two frames (FIG. 1);
the nonbonded complex was preheated between two heated platens allowing the forming temperature to be regulated to within ±2° C. (FIG. 2). The heating temperature was between 90° C. and 105° C.; and
the molds were heated to a temperature between 50 and 70° C. and applied to the complex (FIG. 3).

III. Welding

The welding was the final step in the manufacture of the gloves.

It was performed conventionally using the technique of welding with a thermal pulse produced by tongs.

A product having the general shape of a glove was produced with comfort bumps at the joins, on the back of the glove. The chemical permeation resistance properties were tested using the method described below and gave the results summarized in Table I:

Permeability Measurement Method

Solvents tested:
Tetrahydrofuran (THF)
methyl ethyl ketone (MEK)
dichloromethane (DCM)
toluene
dimethylformamide (DMF)
diethylamine (DEA)

Standard used:
NF EN 374-3

Equipment used for the permeability

Permeation cell, standardized and made up of two parts between which the specimen to be tested was placed:

First part: containing the test chemical (here a solvent)

Second part: collector compartment where the measurement was made.

Chromatograph: Model HP 5890
Oven temperature: 60° C.
Column: HP1 capillary
   30 m×0.53 mm×0.88 μm df apolar stationary phase (methyl silicone) used for THF, MEC, DCM and toluene
Column: VOCOL capillary
   30 m×0.53 mm×3 μm df used for DEA and DMF
Carrier gas: helium, column flow rate 20 ml/min purge flow rate 100 ml/min
   split/splitless injector used in splitness mode at 150° C.
   60° C. isothermal temperature for THF, MEC, DCM, toluene and DEA 100° C. isothermal temperature for DMF.

H₂ FID (flame ionization detector):
Detector temperature: 250° C.
Hydrogen intake pressure: 2 bar
Compressed-air intake pressure: 4 bar

Injection loops: Valco Instruments Co. Inc. (VICI)
Injection every 2 minutes using a timer.

Thermostated bath: Haake
Test temperature: 23±1° C.
Analysis time: 4 hours.

Permeability Measurements

Acids and bases tested:
35% hydrochloric acid
52.5% nitric acid
95% sulfuric acid
85% orthophosphoric acid
100% acetic acid
50% sodium hydroxide

Standard used:
NF EN 374-3

Apparatus:

Standardized permeation cell made up of two parts between which the specimen to be tested was placed. The first part contained the chemical (here the acid or base) and the second part (collector compartment) contained water in which the conductivity measurement was performed:
CDM 230 (Radiometer Analytical) conductivity meter
Probe of the conductivity meter stored in water “Measurement for Windows” software from National Instrument.
Optoelectronic protection equipment between the conductivity meter and the PC.

Preliminary preparations:
0.01M KCl calibration solution
Standard solutions prepared in water (¼ osmosed water+¾ UP (ultrapure) water)

Duration of the analyses: 4 hours.

Evaluation of the permeability behavior of the film

A film was said to be impermeable if its breakdown time, i.e. the time elapsing between the moment when the film is brought into contact with the chemical and the moment when the conductivity measurement demonstrates a permeation flux of 1 μg/min/cm², was greater than 4 hours.

Helium Permeability Measurement

Principle:

The apparatus for measuring the helium permeability of films consisted of:
Adixen (Alcatel) helium detector operating in ASM 142 sniffer mode;
a measurement cell 23.76 cm² in area made up of two glass half-parts and an elastomer seal;
a helium flow device for saturating one of the two half-cells with helium at atmospheric pressure;
a nitrogen flow device for carrying the helium that has passed through the film to a helium detector without a pressure drop, thanks to the adjustment of the nitrogen flow rate and the sniffer flow rate of 60 ml/min; and
A flowmeter for imposing a nitrogen flow rate of 60 ml/min at any moment.

To avoid any contamination by helium in the detector when changing specimens, the measurement cell was preferably placed under a hood and the gas connections made of polyamide or preferably stainless steel.

A recorder connected to the helium detector was used to record the variation over time of the raw signal denoted by S in mbar·l/s, which was equivalent to the instantaneous helium flow. A typical curve showing the regime corresponding to helium dissolving in the material (rapid rise in the signal S upon opening the helium valve) and then the diffusion regime (steady signal S) is presented in FIG. 4.

The starting signal was equal to the value of helium in air, i.e. 5×10⁻⁶ mbar·l/s.

The helium permeability measurement given thereafter in cm³·cm/m²·day·bar was obtained using the signal S obtained in the diffusion regime.

To convert the signal S measured at equilibrium in mbar·l/s to the permeability in cm³·cm/m²·day·bar, all that is required is to multiply the measured signal by 24×3600, going from seconds to day, also multiplying it by the thickness of the film in cm and by dividing it by the area of the cell in m². In the case of the glass cell, ignoring the thickness of the film, the factor is equal to 36363636, i.e.:
P=36363636×S×e, where e is the thickness in cm and S the signal in mbar·l/s.

This technique was initially developed for PVC and virgin polyethylene films, values for which may be found in the literature, and led to the development of an operating method for calibrating the detector.

The choice of measuring the helium permeation is justified by four major advantages:
1) helium is a molecule that dissolves very rapidly and thus should allow the measurement times to be shortened compared with measurement times using solvents, the objective being that of verifying the presence of the contiguous lamellar structure by the diffusion through the material;
2) helium is present in air with a very low concentration (5 ppm)—thus the measurements are barely disturbed and the set-up is simplified;
3) its presence in air allows the measurement to be calibrated; and
4) very sensitive helium detectors (mass spectro-photometers set onto the helium band) exist, and can be used directly.

Application of the Helium Permeability Measurement to the Validation of the Films and the 3D Products

Depending on the conversion conditions (extruder characteristics, extrusion parameters, cooling characteristics), three types of structure were able to be demonstrated:
contiguous lamellar structure or reference structure;
noncontiguous lamellar structure, called lamellar structure; and
nodular structure,

which are shown schematically in FIG. 5.

FIG. 7 shows a micrograph of the film obtained according to the invention (Example 1).

### Example 2 (Comparative Example)

A film was prepared with the same constituents as in Section I above, but differing from Example 1 by the granules not being incorporated into the extruder hopper directly but after the three types of granules had been melt-preblended in a twin-screw extruder. This operation was carried out in a CLEXTRAL BC21 twin-screw extruder having mixing elements combined with reverse pitches in order to optimize the mixing, at a temperature of 200° C.

The film was then extruded in the same manner and with the same parameters as in Example 1.

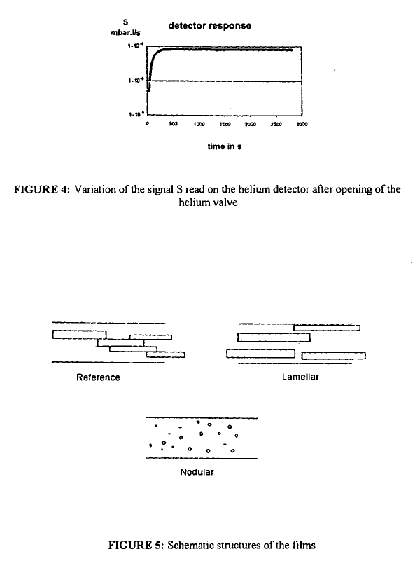

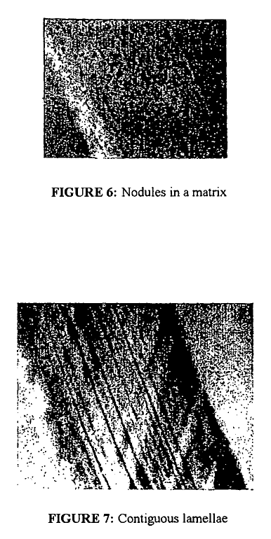

This time, the dispersed phase was observed, in optical microscopy, not to be in the form of lamellae but in the form of nodules a few microns in diameter. The blend was said to have a nodular structure. FIG. 6 shows this structure.

### Example 3 (Comparative Example)

The film of this example was obtained from the film of Example 1, by taking the film of Example 1 (not complexed, not thermoformed and not welded) and preheating it to a temperature of 130° C. before forming it, i.e. at a temperature 30° C. above the melting point of the polyethylene of the matrix.

### Example 4 (Comparative Example)

A film consisting of just polyethylene (the 1008 FE24 PE of the blend) was produced under the extrusion blow molding conditions for the film of Example 1, this film serving as control for comparing the results.

Assessment of the Examples

The helium permeability measurements on these various films and their solvent permeability are given in Table II.

TABLE II

| | | | | Enhancement | THF* | Toluene |
|---|---|---|---|---|---|---|
| | | | | factor | breakdown | breakdown |
| | | Thickness | Permeability | relative to | time | time |
| Example | Structure | (μm) | (cm³ · cm/m² · day · bar) | polyethylene | (in min) | (in min) |
| 1 | Contiguous | 130 | 10 | 4 | >240 | >240 |
| | lamellar | | | | | |
| 2 | Nodular | 140-150 | 40 to 44 | 1 | ˜10 | ˜5 |
| 3 | Noncontiguous | 120-190 | 14 to 20 | 2 to 3 | between 20 | ˜40 |
| | lamellar | | | | and 80 | |
| 4 | Polyethylene | 100 | 42 | 1 | ˜10 | ˜5 |
| | control | | | | | |

*THF = tetrahydrofuran

The breakdown time of a film is the time between the moment when the film is brought into contact with the solvent and when the chromatograph detects a permeation flux of 1 μg·min⁻¹·cm⁻².

Since the area of the film in contact with the solvent was 23.76 cm² and the helium flow rate through the cell was 100 ml/min, the breakdown time of the film was therefore determined as the moment when the permeation flux reached a value of 0.237 g/ml.

The large variations in breakdown times can be explained by the large local variations in the thickness of the films.

The helium permeability of a low-density polyethylene film 100 μm in thickness obtained by blowing the tube is about 40 cm³·cm/m²·day·bar.

The table shows differences in helium permeability values depending on the structure of the blend film.

The nodular film has a value almost equal to that of the polyethylene of the blend.

The film with a noncontiguous lamellar structure has an intermediate value between that of the nodular film and that of the contiguous lamellar film. This is easily explained by the fact that the lamellae are not contiguous and their role is limited to only producing obstacles to the diffusion, which increases the path length and therefore the diffusion time.

As regards the film having a contiguous lamellar structure, its helium permeability is reduced by a factor of 4 compared with that of a PE film or of a nodular blend.

TABLE I
Acid-base permeation

| | | | | Initial conductivity | Final conductivity | Final flux in |
|---|---|---|---|---|---|---|
| Thickness in μm | Chemical | | Behavior | in μS/cm | in μS/cm | μg/min/cm² |
| 140 ± 20 | 35% | hydrochloric acid | Impermeable | 11.1 | 15.5 | 0.022 |
| | 52.5% | nitric acid | Impermeable | 11.4 | 13.6 | 0.030 |
| | 95% | sulfuric acid | Impermeable | 10.9 | 11.6 | 0.041 |
| | 85% | orthophosphoric acid | Impermeable | 9.7 | 11.2 | 0.72 |
| | 100% | acetic acid | Impermeable | 9.8 | 14.1 | 0.417 |
| | 50% | sodium hydroxide | Impermeable | 8.2 | 9.3 | 0.033 |

Solvent permeation

| | | | Final flux in | |
|---|---|---|---|---|
| Thickness in μm | Chemical | Behavior | μg/min/cm² | State of film |
| 140 ± 20 | Dichloromethane (1) | Impermeable | 0.101 | No change |
| | Dichloromethane (2) | Impermeable | 0.067 | No change |
| | Methyl ethyl ketone (1) | Impermeable | 0.000 | No change |
| | Methyl ethyl ketone (2) | Impermeable | 0.000 | No change |
| | Tetrahydrofuran (1) | Impermeable | 0.034 | No change |
| | Tetrahydrofuran (2) | Impermeable | 0.017 | No change |
| | Toluene (1) | Impermeable | 0.417 | No change |
| | Toluene (2) | Impermeable | 0.000 | No change |
| | Diethylamine (1) | Impermeable | 0.400 | No change |
| | Diethylamine (2) | Impermeable | 0.686 | No change |
| | Dimethylformamide (1) | Impermeable | 0.000 | No change |
| | Dimethylformamide (2) | Impermeable | 0.000 | No change |

1. A process for manufacturing a protective article with a contiguous lamellar structure from a heterogeneous material comprising:
(a) a polyolefin or a blend of polyolefins;
(b) at least one material forming a barrier to chemicals, this material having a melting point at least 5° C. above the melting point of the polyolefin
(a); and
(c) at least one compatibilizer for allowing the barrier material (b) to be dispersed in the polyolefin (a),
said process comprising the following steps:
(i) blending of constituents (a), (b) and (c);
(ii) extrusion of the blend obtained at (i) so as to form a film tube;
(iii) stretching of the film tube obtained at (ii); and
(v) thermoforming of the film obtained at (iii), steps (iii) and (v) being controlled so that the thickness of the article at all points is between 60 and 190 μm.

2. The process as claimed in claim 1, characterized in that component (a) is polyethylene.

3. The process as claimed in either of claims 1 and 2, characterized in that component (b) is chosen from: polyamides; polyesters, such as polyethylene terephthalate and polybutylene terephthalate; polycarbonates; ethylene/vinyl alcohol copolymers; polyvinyl acetate and polyvinyl alcohol.

4. The process as claimed in claim 3, characterized in that component (b) is an ethylene/vinyl alcohol copolymer.

5. The process as claimed in any one of preceding claims 1 to 4, characterized in that the compatibilizer (c) is a polyolefin onto which carboxylic units have been grafted.

6. The process as claimed in claim 5, characterized in that the compatibilizer (c) is a polymer comprising polyolefin units onto which cyclic anhydride fragments are grafted, said polyolefin units being compatible with the polyolefin (a), the cyclic anhydride fragments being in an amount such that the percentage by weight of carbonyl functional groups relative to the total weight of the compatibilizer (c) is between 0.1 and 4%.

7. The process as claimed in any one of claims 1 to 6, characterized in that constituents (a), (b) and (c) are introduced in amounts such that: the polyolefin (a) represents from 60 to 95%, preferably 70 to 90%, by weight of the weight of the blend; component (b) represents from 2 to 40%, preferably 3 to 20% and even more preferably 4 to 12%, by weight of the total weight of the blend; and component (c) is introduced in an amount such that the weight of the carbonyl functional groups of compound (c) represents 0.14 to 0.6% of the weight of component (b).

8. The process as claimed in any one of preceding claims 1 to 7, characterized in that solid particles with a size ranging from 0.5 to 10 mm, preferably 1 to 7 mm and even more preferably 2 to 4 mm, are used for the blending (i) of components (a) and (b).

9. The process as claimed in any one of preceding claims 1 to 8, characterized in that, at step (ii), after having prepared a homogeneous blend of the three components, this is conveyed to an extruder in which said blend is heated to a temperature above the melting point of component (b).

10. The process as claimed in any one of preceding claims 1 to 9, characterized in that, at step (ii), the blend is extruded through a die of the radial-channel helical type or of the flat type.

11. The process as claimed in any one of claims 1 to 10, characterized in that the stretching of the tube at step (iii) takes place by stretch blow molding.

12. The process as claimed in any one of claims 1 to 11, characterized in that the cooled film tube is stretched with a blow ratio ranging from 1 to 5, preferably 1.5 to 3, and with a stretch ratio of 1 to 5, preferably 2 to 4.

13. The process as claimed in any one of claims 1 to 12, characterized in that it further includes, between steps (iii) and (v), a step (iv) of complexing with a nonwoven based on a polymer compatible with the polymer (a).

14. The process as claimed in any one of claims 1 to 13, characterized in that it further includes a welding step (vi).

15. A personal protective article, the walls of which are made of a material consisting of:
(a) a continuous polyolefin phase in which is dispersed;
(b) at least one material forming a barrier to chemicals, this material having a melting point at least 5° C. higher than the melting point of the polyolefin (a); and
(c) at least one compatibilizer allowing the barrier material (b) to be dispersed in the polyolefin (a), at least one portion of this article being thermoformed,
this material having a thickness ranging from 60 μm to 190 μm.

16. The article as claimed in claim 15, characterized in that it is in the form of a glove, overshoe, overalls, hood, shroud or cover.

17. The article as claimed in claim 18, characterized in that the material from which it is made has a helium permeability improved by a factor of 4 or more over the polyolefin (a).
